(19) United States
(12) Patent Application Publication
(10) Pub. No.: US 2023/0394565 A1
(43) Pub. Date: Dec. 7, 2023

(54) SYSTEM FOR SLEDS AUTOMATED RENTAL

(71) Applicant: MOBY HEALTH S.R.L., Napoli (IT)

(72) Inventor: Francesco LA MARCA, Ottaviano (NA) (IT)

(21) Appl. No.: 18/247,655

(22) PCT Filed: Oct. 6, 2020
(86) PCT No.: PCT/IT2020/000069

§ 371 Date: Apr. 3, 2023

(51) Int. Cl. G06Q 30/0645; G07F 11/64; G07F 17/00

(52) U.S. Cl. CPC G06Q 30/0645; G07F 17/0057; G07F 11/64

(57) ABSTRACT

The invention realizes a system for sleds' automated rental, consisting of an infrastructure of various shapes and sizes, for the housing both in vertical and in horizontal position of the devices, thanks to a particular shape that constrains the housing in a forced position that allows its block by an electro-mechanical device equipped with a piston. The invention provides the implementation of hardware and sensors to allow any functionality and automation useful for sleds' automated rental.

### TECHNIQUE FIELD TO WHICH THE INVENTION REFERS

Technique field to which the present invention refers is that of systems for the automated rental of sleds.

### PRE-EXISTING TECHNIQUE STATUS INHERENT THE REFERENCE FIELD OF THE INVENTION

To date, there is no system for sleds' automated rental. The rental of said devices is in fact made only through the use of dedicated personnel.

### INVENTION DETAILS AND ADVANTAGES INTRODUCED COMPARED TO THE EXISTING TECHNIQUE

The Invention Consists of:
INF infrastructure for the housing of DIS sleds, both in vertical and horizontal position, characterized by a particular SGM shape that constrains the housing of the DIS device in a forced position that allows its electro-mechanical lock. When the DIS device is positioned, a reader of presence integral with the SGM shaping causes the PIS piston release from the AGC electromechanism which, due to the particular SGM shaping, inhibits the extraction of the DIS slide from the INF infrastructure. Each INF infrastructure housing is demarcated both by a progressive number NP, in Arabic characters, and by the same number converted into a 2D QR code;
AGC electromechanism which, thanks to specific SNS presence sensors, activates the release of the PIS piston by simply positioning the DIS in the housing, locking it in the particular SGM shape of the INF infrastructure. The AGC electromechanism can implement suitable HDW hardware for reading the ID of the DIS device for the application of automated rental protocols, for example by associating the ID of the DIS device with the user who rent/returns it;
MCP microprocessor that governs blocking/unblocking operations both in local, even in the absence of internet connection, and in cloud, processing the information received from the HDW and associating them with users enabled to rent by using a ski pass and/or other RFID ticket and/or NFC and/or barcode and/or QR code or by app and/or booking codes. The MCP microprocessor detected the rental request from a user enabled for the service, activates the AGC electromechanism integral with the INF infrastructure by retracting the PIS piston, thereby releasing the DIS device in favor of the user. The ID of the DIS device is associated with the user ID such that, by repositioning the DIS device in any free housing of the INF infrastructure, MCP automatically closes the rental session.

The benefits provided by the invention in question with respect to the sleds rental services offered today, which we remind are realized only through the use of personnel, are identifiable in their cheapness, efficiency and practicality. With reference to cheapness and efficiency, it should be noted that the invention allows the fully automated operation of the sleds rental service for users, limiting interventions with the use of personnel only to those of ordinary and extraordinary maintenance.

With reference to practicality, it should be noted that, thanks to the particular SGM modeling, which constrains the housing of the DIS device in a forced position, guaranteeing its vertical and/or horizontal position, it is not necessary to make any changes on the DIS devices (eg. brackets, eyelets, plugs, etc . . .) to ensure its locking. When the PIS piston of the AGC electromechanism is in the exit position, the particular SGM shape of the INF infrastructure, in contrast with the normal components of the DIS slide, prevents its pick up.

### DESCRIPTIONS OF DRAWINGS AND DESCRIPTION OF INVENTION APPLICATION

In FIG. 1, FIG. 2, FIG. 3, FIG. 4 and FIG. 5 the invention in question is represented, with indication of the abbreviations previously used.

In particular:
FIG. 1 shows, in its entirety, a representation of the invention. Specifically, the system consists of an INF infrastructure, for the housing of snow sleds in a horizontal and vertical position, and a centralized totem TOT equipped with the rental access hardware (RFID LRFID reader, bar code reader and NFC LCAB and QR Code LQR reader) and the MCP microprocessor. The AGC electromechanism is located in each housing of the INF infrastructure. Some housings are also protected by SPA doors. A PNS shelter has been set up to cover the entire plant from atmospheric agents. This configuration is particularly effective for automated rental even in particular snow conditions;
FIGS. 2, FIG. 3, FIG. 4 and FIG. 5 instead focus on the particular SGM shaping/molding which constrains the housing of the DIS device in a forced position that allows its electro-mechanical lock. SGM acts as a support for the DIS device and, when the PIS piston of the AGC electro-controlled device is in the locked position, acts a contrast for the device, preventing its unauthorized release. The unique association between the ID of the DIS device and the user enabled for the rental service, is guaranteed by SNS sensors, installed on the same DIS, and the corresponding HDW readers. Each housing is identified with a progressive number NP as well as with the same number converted into a 2D QR code.

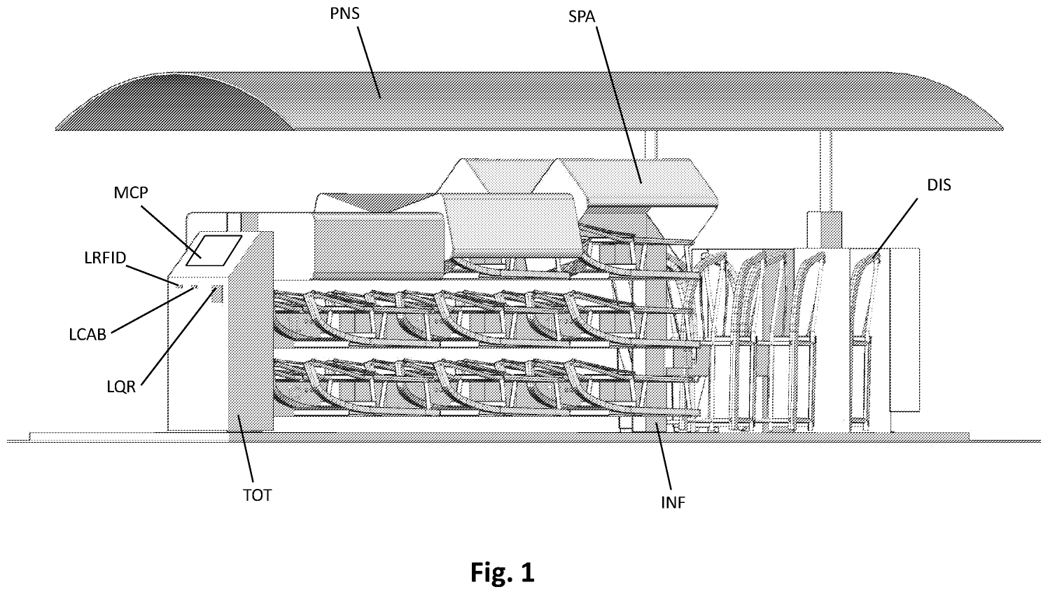

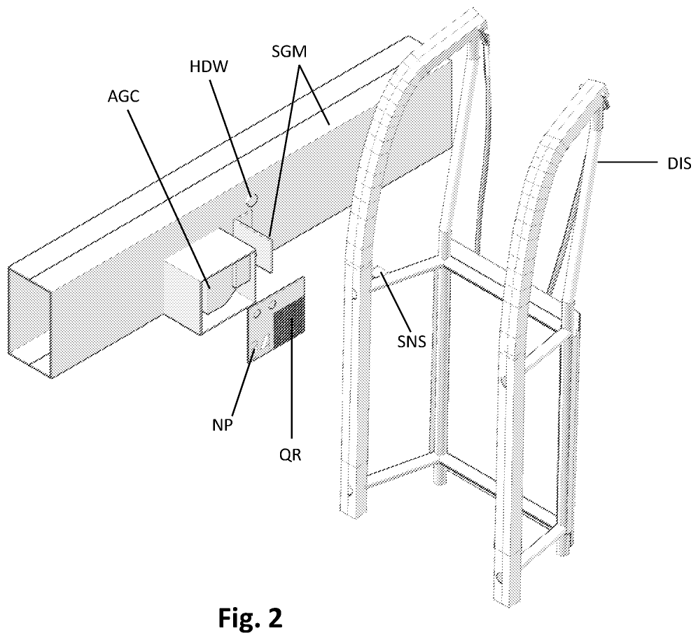

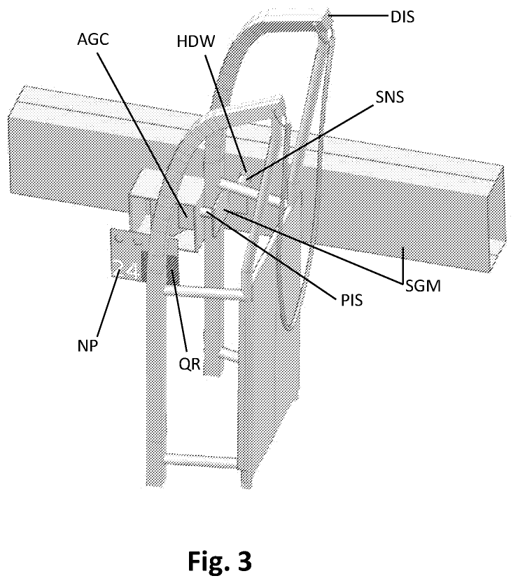

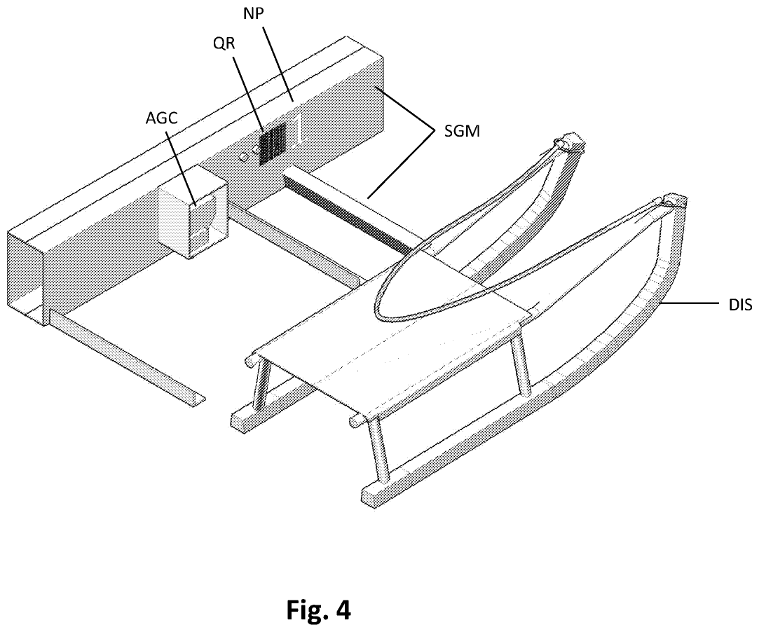

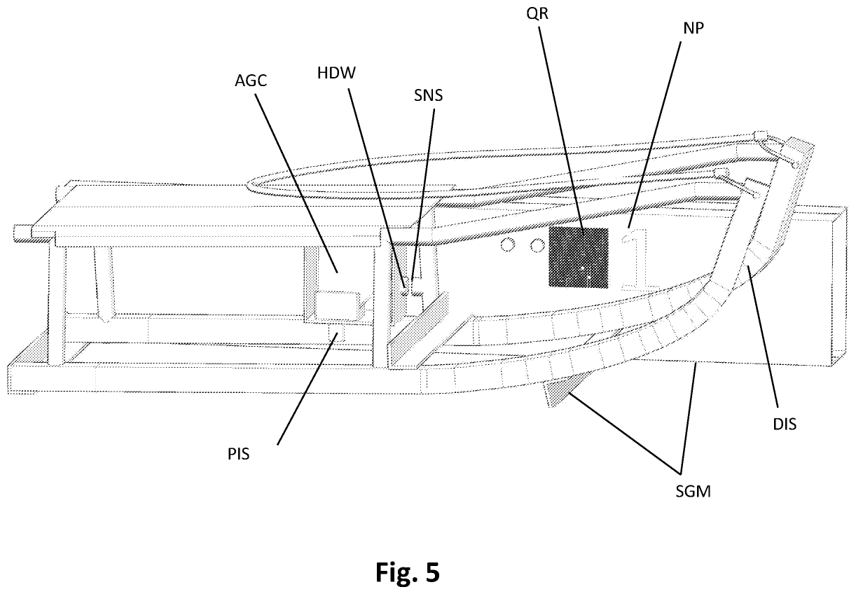

1. Plant for automated rental of sled devices comprising an infrastructure (INF), equipped with a shaped body (SGM) that constrains the housing of the sled device (DIS) in a forced position, vertical and horizontal,
Wherein the infrastructure (INF) comprises an electro-mechanical (AGC) having a piston (PIS) that allows the electro-mechanical lock of the sled device (DIS) when the piston (PIS) comes out operated by the mechanism (AGC).

2. The plant according to claim 1 wherein the shaped body (SGM) of the infrastructure (INF) comprises readers (HWD) of presence sensors applied on the sled device (DIS), in order to automatically activate the electromechanism (AGC) for the exit/retraction of the piston (PIS).

3. The plant according to claim 1 wherein said readers (HWD) being part of at least one of the following presence sensors; RFID sensor; infrared sensors; said sensors being operable for automated rental purposes with the implementation of additional microprocessors and hardware for its operation in local and/or in the cloud.

4. The plant according to claim 1, wherein the infrastructure (INF) implements a photovoltaic shelter for its electrical power supply and protection from atmospheric agents.

5. The plant according to claim 1, wherein the infrastructure (INF) further includes a totem for centralized management of the rental operations of the sled device (DIS)

6. The plant according to claim 1 wherein said shaped body (SGM) is shaped to constrain the housing, in a forced position that allows its electro-mechanical block, also of further gaming and sports devices.

7. The plant according to claim 1, wherein the (infrastructure (INFN) includes doors (SPA) to protect the sled devices (DIS).
